(19) United States
(12) Patent Application Publication
(10) Pub. No.: US 2004/0192551 A1
(43) Pub. Date: Sep. 30, 2004

(54) Herbicidal compositions containing clove oil

(76) Inventor: Steven M. Bessette, Brentwood, TN (US)

Correspondence Address: NIXON & VANDERHYE, PC, 1100 N GLEBE ROAD, 8TH FLOOR, ARLINGTON, VA, 22201-4714, US

(21) Appl. No.: 10/765,093

(22) Filed: Jan. 28, 2004

Related U.S. Application Data
(60) Provisional application No. 60/442,918, filed on Jan. 28, 2003.

(51) Int. Cl. A01N 63/00

(52) U.S. Cl. 504/117

(57) ABSTRACT

Herbicidal compositions containing clove oil as an active ingredient, with or without one or more plant essential oils or an adjuvant/soil amendment and methods for using same are disclosed.

This application claims the benefit of U.S. Provisional Application Serial No. 60/442,918, filed Jan. 28, 2003, the entire disclosure of which is incorporated herein by reference

### FIELD OF THE INVENTION

The present invention relates, in general, to herbicidal compositions. In one aspect, the present invention relates to herbicidal compositions containing clove oil. In another aspect, the present invention relates to herbicidal compositions containing synergistic blends of clove oil and certain other plant essential oils. In a further aspect, the present invention relates to a method for controlling weeds and grasses by the application of pesticidally effective amounts of the herbicidal compositions containing clove oil and/or synergistic blends of clove oil and other plant essential oils to a locus where weed and grass control is desired.

### BACKGROUND OF THE INVENTION

Weed and grass control are essential for, among other things, the efficient production of agricultural and horticultural crops. The use of effective herbicides has been the subject of extensive research and investigation. In farming, the occurrence of weeds and grasses in crops is problematic because they often cause a reduction in the quantity and/or quality of the crop. Weeds and grasses compete with desired crops for water, nutrients, and sunlight, and can also provide a refuge for insects and diseases that could damage the quality and quantity of the crop. Weeds and grasses can also create problems in harvesting operations, and reduce the efficiency of the crop production. In household environments, weeds and grasses are also problematic. In addition to being a nuisance and eyesore in many situations, weeds and certain grasses can also compete with desired plants and grasses in turf and other lawn and garden environments. Herbicide applications for these environments will result in exposure to the general environment, including the water table, of residential and commercial settings.

The widespread use of herbicides has been around since 1940. However, it has become increasingly apparent that the widespread use of synthetic chemical herbicides has caused detrimental environmental effects that are harmful to humans and other animals. For instance, the public has become concerned about the amount of residual chemicals that persist in food, ground water and the environment, and that are toxic, carcinogenic or otherwise incompatible to humans, domestic animals and/or fish. Due to the fact that herbicides are applied to the soil and/or the foliar surfaces, they can easily reach streams, lakes, and reservoirs in water that runs off treated areas. As a result, many herbicide labels currently in use carry groundwater advisory statements regarding herbicide leaching. Worker safety is also an issue when applying these chemicals. Moreover, some target weeds and grasses have even shown an ability to develop immunity to many commonly used synthetic chemical herbicides. In recent times, regulatory guidelines have encouraged a search for potentially less dangerous herbicidal compositions via stringent restrictions on the use of certain synthetic herbicides. As a result, elimination of effective herbicides from the market has limited economical and effective options for controlling weeds and grasses. As an alternative, botanical herbicides are of great interest because they are natural herbicides, i.e., toxicants derived from plants that are safe to humans and the environment.

Accordingly, there is a great need for novel herbicidal compositions containing plant essential oils and synergistic mixtures thereof. In addition, there is a need for methods for using same that address the problems described above, i.e., are safe to humans and the environment and relatively inexpensive to use in obtaining acceptable levels of weed and grass control.

### SUMMARY OF THE INVENTION

A primary object of the present invention is to provide novel and effective herbicidal compositions that contain clove oil as an active ingredient.

Another object of the invention is to provide herbicidal compositions containing an active ingredient comprising synergistic mixtures of clove oil and other plant essential oils.

A still further object of the present invention is to provide a method for controlling weed and grass growth by the application of the compositions of the present invention to a locus where such control is desired.

It is a further object of the present invention to provide a fast-acting, rapid defoliant for pre-harvest applications.

It is still another object of the present invention to provide a novel herbicide that is safe and can be used in conjunction with conventional pesticides including, but not limited to, herbicides.

It is still another object of the present invention to provide a synergist for conventional herbicides, thereby providing quick burn down of plant matter coupled with systemic action on roots using lower rates and amounts of the conventional herbicides or pesticides.

It is still another object of the present invention to provide a non-systemic herbicide that can be used to remove green plant matter without affecting the stem of the plants.

It is a further object to provide a safe, non-toxic herbicidal composition and method that will not harm the environment.

It is a further object of the present invention to provide a novel herbicide that is comprised of food grade materials and is exempt from U.S. Environmental Protection Agency registration.

It is still another object of the present invention to provide a novel herbicide that is comprised of food grade materials and is exempt from tolerance under the U.S. Federal Food and Drug Cosmetic Act.

It is still another object to provide a herbicidal composition and method that has a pleasant scent and that can be applied without burdensome safety precautions.

It is still another object to provide a herbicidal composition and method as described above which can be inexpensively produced or employed.

It is yet another object of the invention to provide a herbicidal composition and method to which weeds and grasses cannot build immunity.

One or more of the above, and other objects, are accomplished by the present invention, which is directed to herbicidal compositions containing clove oil and to herbicidal compositions containing synergistic mixtures of clove oil and other plant essential oils and/or conventionally used herbicides or soil amendments/adjuvants that act by facilitating the uptake of the herbicidal compositions of the present invention into a target weed or grass, such as, but not limited to, humus and humic acid containing materials, e.g., leonardite, etc. In addition, the present invention is directed to a method for controlling weeds and grasses by applying a herbicidally-effective amount of the above herbicidal compositions to a locus where weed and grass control is desired.

Additional objects and attendant advantages of the present invention will be set forth, in part, in the description that follows, or may be learned from practicing or using the present invention. The objects and advantages may be realized and attained by means of the instrumentalities and combinations particularly recited in the working examples and throughout the written description. It is to be understood that the foregoing general description and the following detailed description are exemplary and explanatory only and are not to be viewed as being restrictive of the invention, as it may be ultimately claimed.

### DETAILED DESCRIPTION OF PREFERRED EMBODIMENTS

All patents, patent applications and literatures cited in this description are incorporated herein by reference in their entirety. In the case of inconsistencies, the present disclosure, including definitions, will prevail.

In one embodiment, the present invention provides a herbicidal composition comprising clove oil, in admixture with a suitable carrier and optionally with a suitable surface active agent.

In another embodiment, the present invention comprises an herbicidally acceptable carrier and an active ingredient, which comprises clove oil and at least one plant essential oil, such as, without limitation, wintergreen oil, thymol, thyme oil, and/or carvacrol. In this embodiment, the herbicidal composition of the present invention does not need to contain a toxic or corrosive acid, such as acetic or lactic acid, as an active ingredient, to achieve herbicidal activity. A non-limiting example is a herbicidal composition comprising an herbicidally acceptable carrier (e.g., water, lecithin and/or sodium laurel sulfate) and an active ingredient, wherein the active ingredient either comprises, consists essentially of, or consists of: clove oil and thyme oil.

Clove oil is considered to be as Generally Recognized as Safe (GRAS) as a substance added directly to human food (21 C.F.R. § 184.1257). Clove oil is known and used for other uses, and may be prepared by a skilled artisan by employing known methods. For instance, clove essential oils may be extracted from various parts (e.g., leaves, buds, roots, stems, etc.) of Eugenia caryophyllata (a.k.a. Syzygium aromaticum, Eugenia aromatica, E. carophyllus, etc.) from the Myrtaceae family. Clove extract from leaves (clove leaf oil) is preferred.

Extracts of clove oil comprise a mixture of different compounds. The three significant active ingredients are eugenol, isoeugenol and methyleugenol. Preferably, clove oil that may used in acordance with the present invention contains about 50% to about 95% by weight of eugenol, and about 0% to about 50% by weight of isoeugenol and methyleugenol. Other constituents that may be found in clove oil extracts useful in the present invention include, b-caryophyllene (about 0% to about 15% by weight), a-humulene (about 0% to about 10% by weight), eugenol acetate (about 0% to about 10% by weight), benzyl benzoate (about 0% to about 2% by weight). Alternatively, clove oil-like synthetic compositions can be made containing the above-described components and utilized in accordance with the principals of the present invention. For clarity, the term “clove oil”, as used herein, shall encompass all mixture permutations of mixtures containing the components described above.

It is believed that the various active constituents of clove oil work in combination to provide a more efficacious herbicidal composition compared to compositions containing eugenol alone or eugenol with additional compounds (e.g., plant essential oils) other than as the active ingredient(s) (e.g., other than isoeugenol and methyleugenol).

In a preferred embodiment the present invention relates to a herbicidal composition for agricultural and household use comprising a mixture of clove oil with an emulsifier in water.

Another preferred embodiment relates to herbicidal compositions for household use for (i) broadleaf weed control or (ii) total weed and grass control, comprising clove oil at various dosage rates.

Another preferred embodiment relates to a herbicidal composition for agricultural and household use comprising a mixture of clove oil synergized by the addition of thymol (which includes thyme oil and carvacrol mixtures) and/or wintergreen oil (methyl salicylate).

It will be appreciated by the skilled artisan that the herbicidal compositions of the present invention unexpectedly exhibit herbicidal efficacies without corresponding issues of toxicity to mankind and the environment. It will be further appreciated that the herbicidal compositions of the present invention provide unexpectedly fast action against green plant matter without systemic action against plant roots. Without wishing to be bound by the following theories, it is believed that clove oil acts by disrupting cell membranes in plant tissue, releasing proteins within the plant matter. Alternatively, clove oil may also act by inhibiting amino acid synthesis, thereby precluding the production of certain enzymes that enable the plant cell to produce essential amino acids. Alternatively, clove oil may act as a photosynthesis inhibitor or pigment inhibitor, thereby preventing the plant's conversion of sunlight into chemical energy required for growth and/or the production of certain plant pigments that are necessary for photosynthesis. Regardless of the mechanism by which herbicides of the present invention act, the net toxic effect and herbicidal action of the present invention is heretofore unknown and unexpected.

Use of herbicidal compositions of the present invention generally results in fast, effective weed and grass control, particularly against broadleaf plants. As such, they are advantageously employed as herbicidal agents in uses such as, without limitation, agriculture, defoliants, organic farming, households, lawn and garden, professional pest control, foliage application, solid treatment, soil incorporation application, seedling box treatment, stalk injection and planting treatment, turf and ornamentals, etc.

With respect to use in agriculture settings, the inventive herbicidal compositions are so chemically inert that they are compatible with substantially any other constituents of a spray schedule. They may also be used in combination with other pesticidally active compounds, including other herbicides.

Examples of plant families that include species of plants that are controlled by the herbicidal composition of the present invention, include, without limitation, the following

| Common Family Name | Scientific Name |
|---|---|
| Borage | Boraginaceae |
| Broomrape | Orobanchaceae |
| Buckwheat | Polygonaceae |
| Caltrop | Zygophyllaceae |
| Carrot | Apiaceae |
| Cashew | Anacardiaceae |
| Cattail | Typhaceae |
| Figwort | Scrophulariaceae |
| Geranium | Geraniaceae |
| Grass | Poacea |
| Goosefoot | Chenopodiaceae |
| Legume | Fabaceae |
| Loasa | Loasaceae |
| Loosestrife | Lythraceae |
| Madder | Rubiaceae |
| Mallow | Malvaceae |
| Mint | Lamiaceae |
| Mistletoe | Loranthaceae |
| Morningglory | Convolvulaceae |
| Mustard | Brassicaceae |
| Nettle | Urticaceae |
| Nightshade | Solanaceae |
| Pickerelweed | Pontedericaceae |
| Pigweed | Amaranthaceae |
| Pink | Caryophyllaceae |
| Plantain | Plantaginaceae |
| Primrose | Primulaceae |
| Purslane | Portulacaceae |
| Rose | Rosaceae |
| Sedge | Cyperaceae |
| Spurge | Euphorbiaceae |
| Sunflower | Asteraceae |
| Waterplantain | Alismataceae |
| Waterweed | Hydrocharitaceae |
| Willowherb | Onagraceae |
| Woodsorrel | Oxalidaceae |

The term “carrier” as used herein means an inert or fluid material, which may be inorganic or organic and of synthetic or natural origin, with which the active compound is mixed or formulated to facilitate its application to the plant, seed, soil or other object to be treated, or its storage, transport and/or handling. In general, any of the materials customarily employed in formulating pesticides, herbicides, miticides or fungicides, are suitable. The inventive herbicidal compositions of the present invention may be employed alone or in the form of mixtures with such solid and/or liquid dispersible carrier vehicles and/or other known compatible active agents, especially plant protection agents, such as other pesticides, or insecticides, miticides, acaricides, nematicides, fungicides, bactericides, rodenticides, fertilizers, growth-regulating agents, etc., if desired, or in the form of particular dosage preparations for specific application made therefrom, such as solutions, emulsions, suspensions, powders, pastes, and granules which are thus ready for use. The herbicidal compositions of the present invention can be formulated or mixed with, if desired, conventional inert pesticide diluents or extenders of the type usable in conventional pesticide formulations or compositions, e.g. conventional pesticide dispersible carrier vehicles such as solutions, emulsions, suspensions, emulsifiable concentrates, spray powders, pastes, soluble powders, dusting agents, granules, foams, pastes, tablets, aerosols, natural and synthetic materials impregnated with active compounds, microcapsules, coating compositions for use on seeds, as well as ULV cold mist and warm mist formulations, etc.

Formulations containing the herbicidal compositions of the present invention may be prepared in any known manner, for instance with conventional pesticide dispersible liquid diluent carriers and/or dispersible solid carriers optionally with the use of carrier vehicle assistants, e.g. conventional pesticide surface-active agents, including emulsifying agents and/or dispersing agents, whereby, for example, in the case where water is used as diluent, organic solvents may be added as auxiliary solvents. Suitable liquid diluents or carriers include water, petroleum distillates, or other liquid carriers with or without surface active agents. The choice of dispersing and emulsifying agents and the amount employed is dictated by the nature of the composition and the ability of the agent to facilitate the dispersion of the herbicidal compositions of the present invention. Generally, it is desirable to use as little of the agent as is possible, consistent with the desired dispersion of the herbicidal compositions of the present invention in the spray so that rain does not re-emulsify the herbicidal compositions of the present invention after it is applied to the plant and wash it off the plant. Non-ionic, anionic, amphoteric, or cationic dispersing and emulsifying agents may be employed, for example, the condensation products of alkylene oxides with phenol and organic acids, alkyl aryl sulfonates, complex ether alcohols, quaternary ammonium compounds, and the like.

Liquid concentrates may be prepared by dissolving a composition of the present invention with a solvent and dispersing the herbicidal compositions of the present inventions in water with the acid of suitable surface active emulsifying and dispersing agents. Examples of conventional carrier vehicles for this purpose include, but are not limited to, aerosol propellants which are gaseous at normal temperatures and pressures, such as Freon; inert dispersible liquid diluent carriers, including inert organic solvents, such as aromatic hydrocarbons (e.g. benzene, toluene, xylene, alkyl naphthalenes, etc.), halogenated especially chlorinated, aromatic hydrocarbons (e.g. chloro-benzenes, etc.), cycloalkanes, (e.g. cyclohexane, etc.). paraffins (e.g. petroleum or mineral oil fractions), chlorinated aliphatic hydrocarbons (e.g. methylene chloride, chloroethylenes, etc.), alcohols (e.g. methanol, ethanol, propanol, butanol, glycol, etc.) as well as ethers and esters thereof (e.g. glycol monomethyl ether, etc.), amines (e.g. ethanolamine, etc.), amides (e.g. dimethyl formamide etc.) sulfoxides (e.g. dimethyl sulfoxide, etc.), acetonitrile, ketones (e.g. acetone, methyl ethyl ketone, methyl isobutyl ketone, cyclohexanone, etc.), and/or water; as well as inert dispersible finely divided solid carriers such as ground natural minerals (e.g. kaolins, clays, vermiculite, alumina, silica, chalk, i.e. calcium carbonate, talc, attapulgite, montmorillonite, kieselguhr, etc.) and ground synthetic minerals (e.g. highly dispersed silicic acid, silicates, e.g. alkali silicates, etc.).

Surface-active agents, i.e., conventional carrier vehicle assistants, that may be employed with the present invention include, without limitation, emulsifying agents, such as non-ionic and/or anionic emulsifying agents (e.g. polyethylene oxide esters of fatty acids, polyethylene oxide ethers of fatty alcohols, alkyl sulfates, alkyl sulfonates, aryl sulfonates, albumin hydrolyzates, etc. and especially alkyl arylpolyglycol ethers, magnesium stearate, sodium oleate, etc.); and/or dispersing agents such as lignin, sulfite waste liquors, methyl cellulose, etc.

In the preparation of wettable powders, dust or granulated formulations, the active ingredient is dispersed in and on an appropriately divided carrier. In the formulation of the wettable powders the aforementioned dispersing agents as well as lignosulfonates can be included. Dusts are admixtures of the compositions with finely divided solids such as talc, attapulgite clay, kieselguhr, pyrophyllite, chalk, diatomaceous earth, vermiculite, calcium phosphates, calcium and magnesium carbonates, sulfur, flours, and other organic and inorganic solids which act as carriers for the pesticide. These finely divided solids preferably have an average particle size of less than about 50 microns. Granules may comprise porous or nonporous particles. The granule particles are relatively large, a diameter of about 400-2500 microns typically. The particles are either impregnated or coated with the inventive herbicidal compositions from solution. Granules generally contain 0.05-25%, preferably 5-15%, active ingredient as the pesticidally-effective amount. Thus, those contemplated are formulations with solid carriers or diluents such as bentonite, fullers earth, ground natural minerals, such as kaolins, clays, talc, chalk, quartz, attapulgite, montmorillonite or diatomaceous earth, vermiculite, and ground synthetic minerals, such as highly-dispersed silicic acid, alumina and silicates, crushed and fractionated natural rocks such as calcite, marble, pumice, sepiolite and dolomite, as well as synthetic granules of inorganic and organic meals, and granules of organic materials such as sawdust, coconut shells, corn cobs and tobacco stalks. Adhesives, such as carboxymethyl cellulose, natural and synthetic polymers, (such as gum arabic, polyvinyl alcohol and polyvinyl acetate), and the like, may also be used in the formulations in the form of powders, granules or emulsifiable concentrations.

If desired, colorants such as inorganic pigments, for example, iron oxide, titanium oxide and Prussian Blue, and organic dyestuffs, such as alizarin dyestuffs, azo dyestuffs or metal phthalocyanine dyestuffs, and trace elements, such as salts of iron, manganese, boron, copper, cobalt, molybdenum and zinc may be used.

If desired, volatile organic compounds suitable as the fragrance ingredient for use in formulations for household applications, include, but are not limited to, amyl salicylate, citronellol, citronelloxyacetaldehyde, cyclamen aldehyde, citronellyl isobutyrate, coumarin, cyclohexyl acetate, cyclohexyl butyrate, diethyl malonate, ethyl 2-acetyl-5-ketohexanoate, isobornyl acetate, linalool, phenethyl alcohol, undecanol, alpha-hexylcinnamaldehyde, 2-methylhexanol, hexalon, phenylacetaldehyde, cis-3-hexen-1-ol, cyclamal, veronol, eugenol, Lyral, Galaxolide, Citralva, musk ambrelte, terpinyl acetate, geraniol, alpha-damascone, alpha-methylionone, and the like. Illustrative of volatile essential oils are oil of Bergamot, cedar leaf, cedar wood, geranium, lavender, white cedar, sandalwood oil, rose extract, violet extract, galbanum oil, and the like. Synthetic types of organic fragrances are described in publications such as U.S. Pat. Nos. 4,314,915; 4,411,829; and 4,434,306.

In commercial or agricultural applications, the present invention encompasses carrier composition mixtures in which the active ingredient in the herbicidal compositions is present in an amount substantially between about 0.01-95% by weight, preferably about 0.5-90% by weight, and more preferably about 5-50% by weight of the mixture, whereas carrier composition mixtures suitable for direct application or field application generally contemplate those in which the active compound is present in an amount substantially between about 0.0001-10%, preferably 1-7%, by weight of the mixture. In liquid formulations, active ingredient in the herbicidal compositions is present in an amount substantially between about 0.01-95% by volume (i.e., v/v), preferably about 0.5-90% by volume, and more preferably about 5-50% by volume of the finished or bulk product, whereas carrier composition mixtures suitable for direct application or field application generally contemplate those in which the active compound is present in an amount substantially between about 0.0001-10%, preferably 1-7%, by volume. Thus, the present invention contemplates over-all formulations that comprise mixtures of a conventional dispersible carrier vehicle such as (1) a dispersible inert finely divided carrier solid, and/or (2) a dispersible carrier liquid such as an inert organic solvent and/or water, preferably including a surface-active effective amount of a carrier vehicle assistant, e.g. a surface-active agent, such as an emulsifying agent and/or a dispersing agent, and an amount of the active compound which is effective for the purpose in question and which is generally between about 0.0001-95%, preferably about 0.01-95%, and more preferably about 5-50% by weight of the mixture.

The herbicidal compositions can also be used in accordance with the so-called ultra-low-volume process, i.e. by applying such compounds or by applying a liquid composition containing the same, via very effective atomizing equipment, in finely divided form, e.g. average particle diameter of from 50-100 microns, or even less, i.e. mist form, for example by airplane crop spraying techniques. Only up to at most about a few liters/hectare are needed. In this process it is possible to use highly concentrated liquid compositions with said liquid carrier vehicles containing from about 20 to about 95% by weight of the herbicidal compositions or even the 100% active substances alone, e.g. about 20-100% by weight of the herbicidal compositions. The mixture of active materials may be applied, without limitation, in sufficient amounts so as to provide about 0.2 to about 20 and preferably about 7 to about 10 pounds of active materials per acre. Moreover, the required amount of the herbicidal composition contemplated herein may be applied per acre treated in from 1 to about 200 gallons or more of liquid carrier and/or diluent or in from about 5 to about 500 pounds of inert solid carrier and/or diluent. The concentration in the liquid concentrate will usually vary from about 10 to about 95 percent by weight and in the solid formulations from about 0.5 to about 90 percent by weight. Satisfactory sprays, dusts, or granules for general use contain from about ¼ to about 30 pounds of active herbicidal compositions per acre.

Furthermore, the present invention encompasses methods for killing, combating or controlling weeds and grasses, which comprises applying to at least one of correspondingly (a) such weeds and grasses and (b) the corresponding field, i.e. the locus to be protected, e.g. to a growing crop, to an area where a crop is to be grown, a correspondingly combative, a pesticidally effective amount, or toxic amount of the particular herbicidal compositions of the invention alone or together with a carrier as noted above. The instant formulations or compositions may be applied in any suitable usual manner, for instance by spraying, atomizing, vaporizing, scattering, dusting, watering, squirting, sprinkling, pouring, fumigating, and the like. The method for controlling weeds and grasses comprises applying the inventive composition, ordinarily in a formulation of one of the aforementioned types, to a locus or area to be protected from the weeds and grasses, such as the agricultural fields, turf and ornamentals, lawn and garden, rights of way, concrete pathways and driveways, etc. The compound, of course, is applied in an amount sufficient to effect the desired action. This dosage is dependent upon many factors, including the targeted plant, the carrier employed, the method and conditions of the application, whether the formulation is present at the locus in the form of an aerosol, or as a film, or as discrete particles, the thickness of film or size of particles, and the like. Proper consideration and resolution of these factors to provide the necessary dosage of the active compound at the locus to be protected are within the skill of those versed in the art. In general, however, the effective dosage of the compound of this invention at the locus to be protected—i.e., the dosage with which the plant matter comes in contact is on the order of about 0.001 to about 0.7% based on the total weight of the formulation, though under some circumstances the effective concentration will be as little as about 0.0001% or as much as about 25%, on the same basis. In any event, optimally effective concentrations may be readily determined by a skilled artisan using routine experimentation.

The herbicidal compositions and methods of the present invention are effective against a wide variety of pesticidal plant matter and it will be understood that the weeds and grasses exemplified and evaluated in the working Examples herein are merely representative of such a wider variety.

The composition and method of the present invention will be further illustrated in the following, non-limiting Examples. All percentages in the Examples below denote v/v measurements unless otherwise noted. The Examples are illustrative of various embodiments only and do not limit the claimed invention regarding the materials, conditions, weight ratios, process parameters and the like recited herein. It should be understood that the specified materials and conditions are important in practicing the invention but that unspecified materials and conditions are not excluded so long as they do not prevent the benefits of the invention from being realized. Other suitable compositions and methods and starting materials will be evident to those having skill in the art.

### EXAMPLE 1

### Herbicidal Effect of Clove Oil Against Broadleaf Weeds and Grasses

Studies were conducted to determine the herbicidal activity of clove oil against a variety of broadleaf weeds and grasses. The formulation tested contained about 5% clove oil solution in water with lecithin as an emulsifier.

The studies were performed in a greenhouse on a standard set of 16 weed species. The mixture was placed, as is, into a hand-held, pump sprayer. The sprayer was pressurized and the nozzle adjusted to a fine, cone-shaped spray pattern. All applications were made to runoff and the actual spray volume applied was quantified.

The application of the clove oil emulsion caused complete death of all weeds within about 2-3 days).

This data shows that the application of an herbicide spray containing clove oil resulted in rapid burn down of green matter and was highly effective in controlling a broad range of weeds.

### EXAMPLE 2

### Herbicidal Effects of Clove Oil with Thymol and Wintergreen Oil Against Broadleaf Weeds and Grasses

Studies were conducted to determine the herbicidal activity of clove oil with thymol (comprising thyme oil and carvacrol) and wintergeen oil (methyl salicylate) against a variety of broadleaf weeds and grasses located in Fresno, Calif. The formulation tested contained a about 10% essential oil solution (clove oil, thymol and wintergreen oil (a.k.a. methyl salicylate) in water with about 0.5% Latron B-1956 as an emulsifier. The essential oil mixture had the following ingredient ratios:

Clove Oil (about 10% v/v)

Thymol (about 40% v/v)

Wintergreen Oil (methyl salicylate) (about 50% v/v)

The studies were performed in a greenhouse on a standard set of 16 weed species. The mixture was placed, as is, into a hand-held, pump sprayer. The sprayer was pressurized and the nozzle adjusted to a fine, cone-shaped spray pattern. All applications were made at about 50 gallons per acre and about 100 gallons per acre. In all cases, the 100 gallons per acre spray rate was more effective than the 50 gallons per acre spray rate. The herbicide formulation provided rapid burn down of green matter and good control of the weed species tested.

This data clearly shows that the amount of surface coverage affects the efficacy of the herbicidal composition. In addition, thymol and wintergreen oil enhanced the herbicidal effects of clove oil at rates suitable for agricultural uses/applications.

### EXAMPLE 3

### Efficacy of Clove Oil Containing Composition (with and without Adjuvant) Against Various Weed Species Located in Fresno, Calif.

Studies were conducted to determine the herbicidal activity of a clove oil containing test composition against broad leaf weeds (common purslane (Portulaca oleracea), hairy nightshade (Solanum sarrachoides), smooth pigweed (Amaranthus spp.), Wild Oat (Avena fatua), and venice mallow (Hibiscus trionum)) and grasses (giant foxtail (Setaria magna), and barnyardgrass (Echinochloa crus-galli) ranging about 3-5 inches in height and located in Fresno, Calif. A summary of the results is shown in Tables 1 and 2 below.

The test composition contained clove oil (about 45.6% v/v) as the active ingredient and water/lecithin (about 54.4% v/v) as the carrier (per 2.5 gallons of test composition) and is listed as “Clove Oil” in the tables. For certain test runs, a leonardite-based adjuvant/soil amendment liquid containing humic acid (about 84-86%) and fulvic acid (about 53-55%)) with and without parrafinic oil (a.k.a. white mineral oil), was mixed with the test composition at various ratios as indicated in Tables 1 and 2 and applied to the target weeds and grasses. In the tables, the adjuvant is listed as “HS” while the white mineral oil is listed as “SO”. General conditions for the tests were as follow:

Plot Size: Six or eight 4×4 inch pots each containing one particular weed species, were placed in 15 inch×30 inch surface area. A distance of 2 inch was kept between the pots.

Replications: Application to each plot was replicated 5 times.

Experimental Layout: After the treatments, the plots were arranged in a randomized complete block design.

Study Conditions: 74-102° F. and 47-61% relative humidity. Clear day.

Application Time: Late summer, mid-day

Spray equipment and pressure: Back pack sprayer (2.5 gallon volume) at about 30 psi

Spray Volume: Equivalent to 100 gallons/acre

At 3 and 6 hours after treatment, the number of weeds appeared wilted & burned in all treatments that included an adjuvant (e.g., HS or HS and SO) compared to treatments without an adjuvant. Observations made at 3 and 6 hours after treatment also indicated that the speed of control was higher when HS 2.5% was included with all rates of the test composition. SO did not appear to enhance the herbicidal activity of the test composition.

As a control, HS at 2.5% alone and HS at 5.0% mixed with SO at 1% was applied to the target plants and showed no herbicidal activity against smooth pigweed, Venice mallow, and giant foxtail or wild oat (data not shown in Tables 1 and 2). As the data in the Tables 1 and 2 show, the test composition at 2.5% applied alone or with HS at 2.5% and SO at 1% showed little or no herbicidal effect. The test composition at 3.5% showed some effect on hairy nightshade, smooth pigweed and barnyardgrass, but no or little effect was observed on other weed species. The effect was higher when HS (at 2.5% and 5.0%) was included with the test composition application, especially against the three of weed species. Further, the test composition at 5.0% provided excellent control against the weed species at 2 days after treatment. The level of control was lower at 1 day after treatment. When HS at 2.5% was applied with the test composition, excellent control was observed 1 day after treatment against all weed species. The test composition at 10% provided excellent control against all weed species at 1 and 2 days after treatment. HS and SO did not contribute to the efficacy of the test composition at 10%. Finally, the addition of SO to the test composition and HS showed little or no impact on herbicidal efficacy.

The addition of HS at 2.5% to the test composition at 3.5% and 5.0% increased the speed of control (1 day vs. 2 day after treatment) and the levels of control. Better results were obtained with the test composition at 5.0%+HS at 2.5% and the test composition 10% with or without HS. In addition, the test composition at 3.5%+HS at 2.5% was not equally effective against all the weed species.

TABLE 1

| | Number of Broadleaf Weeds (n = 5) Burned Down | | | | | | | |
|---|---|---|---|---|---|---|---|---|
| Treatment Composition | Common Purslane | | Hairy Nightshade | | Smooth Pigweed | | Venice Mallow | |
| (v/v %) | 1 DAT | 2 DAT | 1 DAT | 2 DAT | 1 DAT | 2 DAT | 1 DAT | 2 DAT |
| Clove Oil 2.5% | 0 | 0 | 0 | 1 | 0 | 0 | 0 | 1 |
| Clove Oil 3.5% | 0 | 0 | 2 | 2 | 1 | 3 | 0 | 1 |
| Clove Oil 5.0% | 2 | 2 | 2 | 5 | 3 | 5 | 1 | 3 |
| Clove Oil 10% | 3 | 5 | 5 | 5 | — | — | — | — |
| Clove Oil 2.5% + HS 2.5% | 0 | 0 | 0 | 0 | 0 | 2 | 1 | 1 |
| Clove Oil 2.5% + HS 2.5% + SO 1% | 0 | 0 | — | — | — | — | 2 | 2 |
| Clove Oil 3.5% + HS 2.5% | 3 | 3 | 2 | 5 | 5 | 5 | 2 | 3 |
| Clove Oil 3.5% + HS 2.5% + SO 1% | 3 | 3 | — | — | 4 | 5 | — | — |
| Clove Oil 3.5% + HS 5.0% + SO 1% | 4 | 4 | 4 | 5 | — | — | — | — |
| Clove Oil 5.0% + HS 2.5% | 4 | 5 | 5 | 5 | 4 | 5 | 5 | 5 |
| Clove Oil 5.0% + HS 2.5% + SO 1% | — | — | — | — | 5 | 5 | 5 | 5 |
| Clove Oil 10% + HS 2.5% | 5 | 5 | 5 | 5 | — | — | — | — |
| Control (Water) | — | — | — | — | 0 | 0 | 0 | 0 |

| | Number of Broadleaf Weeds (n = 5) Burned Down | | | | | | | |
|---|---|---|---|---|---|---|---|---|
| Treatmentt Composition | Giant Foxtail | | Barnyardgrass | | Wild Oat | | Venice Mallow | |
| (v/v %) | 1 DAT | 2 DAT | 1 DAT | 2 DAT | 1 DAT | 2 DAT | 1 DAT | 2 DAT |
| Clove Oil 2.5% | 0 | 0 | 0 | 0 | 1 | 1 | 0 | 1 |
| Clove Oil 3.5% | 0 | 0 | 0 | 3 | 0 | 1 | 1 | 1 |
| Clove Oil 5.0% | 2 | 5 | 3 | 5 | 5 | 5 | 3 | 5 |
| Clove Oil 10% | 5 | 5 | — | — | — | — | 5 | 5 |
| Clove Oil 2.5% + HS 2.5% | 0 | 1 | 0 | 1 | 0 | 1 | 0 | 0 |
| Clove Oil 2.5% + HS 2.5% + SO 1% | 0 | 0 | — | — | — | — | 0 | 1 |
| Clove Oil 3.5% + HS 2.5% | 3 | 3 | 5 | 5 | 2 | 5 | 3 | 3 |
| Clove Oil 3.5% + HS 2.5% +SO 1% | 2 | 4 | — | — | 3 | 5 | — | — |
| Clove Oil 3.5% + HS 5.0% + SO 1% | 4 | 4 | — | — | 4 | 4 | — | — |
| Clove Oil 5.0% + HS 2.5% | 5 | 5 | 5 | 5 | 4 | 5 | 4 | 5 |
| Clove Oil 5.0% + HS 2.5% + SO 1% | — | — | 5 | 5 | — | — | 4 | 5 |
| Clove Oil 10.% + HS 2.5% | 5 | 5 | — | — | — | — | 5 | 5 |
| Control (Water) | 0 | 0 | — | — | 0 | 0 | — | — |

### EXAMPLE 4

### Efficacy of Clove Oil Containing Composition (with and without Adjuvant) Against Various Weed Species in Pecan Orchard

A composition of the present invention was tested on broad leaf weeds (common purslane (Portulaca oleracea), lambsquarter (Chenopodium album), velvetleaf (Abutilon theophrasti), and annual sowthistle (Sonchus oleraceus)) and grasses (Black nightshade (Solanum nigrum)) ranging about 2-5 inches in height and located in a pecan orchard in Arizona. A summary of the results is shown in Tables 3 and 4 below.

The test composition contained clove oil (about 45.6% (v/v)) as the active ingredient and water/lecithin (about 54.4% (v/v)) as the carrier (per 2.5 gallons of test composition) and is listed as “Clove Oil” in the tables. For certain test runs, a leonardite-based adjuvant/soil amendment liquid containing humic acid (about 84-86%) and fulvic acid (about 53-55%)) with and without parrafinic oil (a.k.a. white mineral oil), was mixed with the test composition at various ratios as indicated in Tables 3 and 4 and applied to the target weeds and grasses. In the tables, the adjuvant is listed as “HS” while the white mineral oil is listed as “SO”. General conditions for this test were as follow:

Plot Size: An area of 8 feet wide×102 feet long between two rows of pecan trees was divided into 7 plots. Each plot was 6 feet wide×10 feet long. A distance of 3 feet was kept between the plots. Plot number correspond to the treatment list in Tables 3 and 4 below.

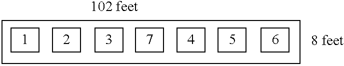

Study Conditions: 91°-106° F. and 22-31% relative humidity.

Application Time: Late Summer, mid-day

Spray equipment and pressure: Back pack sprayer with 6 feet spray boom, containing 4 nozzles at about 35 psi.

Spray Volume: Equivalent to 100 gallons/acre

As the data shows, the addition of HS or HS and SO enhanced the efficacy of the test composition at about 3.5%. The percentage control with the test composition at about 3.5% rate with HS or HS+SO ranged between 60%-100%. With the exception of purslane, the test composition applied at 5.0% rate with or without HS provided about 80%-100% control. The addition of HS to the test composition increased the control level of purslane from about 37.5% to about 90.4%. The test composition at 10% rate exhibited 85.6% to 100% control of the five weed species. Under current study conditions, the contribution of SO was not clearly detected when it was included with the test composition at 3.5% rate and HS. At 3 hours after treatment, the number of weeds wilted or burned down were higher in all treatments that included HS or HS+SO.

TABLE 3

| | Number of Live (L) and Dead (D) Weeds, 2 Days After Treatment | | | | | | | | | |
|---|---|---|---|---|---|---|---|---|---|---|
| Treatment Composition | Purslane | | Lambsquarter | | Velvetleaf | | Sowthistle | | Nightshade | |
| (v/v %) | L | D | L | D | L | D | L | D | L | D |
| 1. Clove Oil 3.5% | 12 | 3 | 7 | 4 | 5 | 3 | 1 | 4 | 4 | 2 |
| 2. Clove Oil 5.0% | 5 | 3 | 1 | 7 | 0 | 5 | 2 | 8 | 1 | 5 |
| 3. Clove Oil 10% | 1 | 10 | 0 | 8 | 0 | 21 | 1 | 6 | 0 | 4 |
| 4. Clove Oil 3.5% + HS 2.5% | 6 | 11 | 0 | 3 | 1 | 8 | 2 | 13 | — | — |
| 5. Clove Oil 3.5% + HS 2.5% + SO 1% | 4 | 6 | 2 | 7 | 2 | 5 | 0 | 2 | 1 | 8 |
| 6. Clove Oil 5.0% + HS 2.5% | 2 | 19 | 1 | 16 | 1 | 10 | 0 | 7 | 0 | 5 |
| 7. Check (Water) | 6 | 0 | 24 | 0 | 10 | 0 | 7 | 0 | 11 | 0 |

TABLE 4

| Treatment Composition | % of Dead Weeds, 2 Days after Treatment | | | | |
|---|---|---|---|---|---|
| (v/v %) | Purslane | Lambsquarter | Velvetleaf | Sowthistle | Nightshade |
| 1. Clove Oil 3.5% | 20% | 36.3% | 37.5% | 80% | 33.3% |
| 2. Clove Oil 5.0% | 37.5% | 87.5% | 100% | 80% | 83.3% |
| 3. Clove Oil 10% | 90.9% | 100% | 100% | 85.6% | 100% |
| 4. Clove Oil 3.5% + HS 2.5% | 64.6% | 100% | 88.8% | 86.7% | — |
| 5. Clove Oil 3.5% + HS 2.5% +SO 1% | 60% | 70% | 71.4% | 100% | 88.8% |
| 6. Clove Oil 50% + HS 2.5% | 90.4% | 94.1% | 90.9% | 100% | 100% |
| 7. Check (Water) | 0 | 0 | 0 | 0 | 0 |

As can be seen from the above discussion, the herbicidal combinations of active ingredients according to the present invention are markedly superior to known herbicidal agents/active compounds conventionally used for control of, for example, weeds and grasses.

Although illustrative embodiments of the invention have been described in detail, it is to be understood that the present invention is not limited to those precise embodiments, and that various changes and modifications can be effected therein by one skilled in the art without departing from the scope and spirit of the invention as defined by the appended claims.

What is claimed is:

1. A herbicidal composition comprising, an herbicidally acceptable carrier and an active ingredient, wherein the active ingredient comprises clove oil.

2. The herbicidal composition of claim 1, wherein the active ingredient further comprises thymol.

3. The herbicidal composition of claim 2, wherein the active ingredient further comprises methyl salicylate.

4. The herbicidal composition of claim 1, wherein the active ingredient further comprises an adjuvant.

5. The herbicidal composition of claim 4, wherein the adjuvant comprises humic acid.

6. The herbicidal composition of claim 5, wherein the adjuvant further comprises fulvic acid.

7. A herbicidal composition comprising, an herbicidally acceptable carrier and an active ingredient, wherein the active ingredient consists essentially of clove oil and thyme oil.

8. A method for killing weeds and grasses, the method comprising:
applying to a weed or a grass the composition of claim 1.

9. A method for killing weeds and grasses, the method comprising:
applying to a weed or a grass the composition of claim 4.

10. A method for killing weeds and grasses, the method comprising:
applying to a weed or a grass the composition of claim 7.
